(19) United States
(12) Patent Application Publication
(10) Pub. No.: US 2010/0037828 A1
(43) Pub. Date: Feb. 18, 2010

(54) Anti-bacterial wet wipe, reversible to plastic poop bag

(76) Inventor: Elena Loizides, Astorin, NY (US)

Correspondence Address: Elena Loizides, APT 2B, 30-32-31 STR, ASTORIA, NY, 11102, US

(21) Appl. No.: 12/228,442

(22) Filed: Aug. 13, 2008

(51) Int. Cl. A01K 29/00

(52) U.S. Cl. 119/161

(57) ABSTRACT

An anti-bacterial wet-wipe, reversible to scented plastic poop bag. Utilized to clean, sanitize, and collect and contain animal waste. Especially for wiping canine buttocks, but not limited to, and fur from feces after defecation in order to prevent insect bites that cause disease by way of bacteria. Wiping, picking up and securing of fecal matter of animal are made easy. Two unique layers; an anti-bacterial wet wipe and a water-repellent scented, odor eliminating plastic layer, defined by a hollow material for the insertion for the hand and thumb placement. Outer layer of medicated or natural (anti-bacterial) solution made of cotton material, but not limited to. At the edge of the inner plastic layer, an adhesive tape/strip that secures fecal matter (animal waste) inside before disposal. With this present invention, it is possible to provide a thumb insertion in mitten-like fashion, thus offering a great flexibility during wiping, cleaning, and picking up of substances (fecal matter), without contamination to the hands. This present invention may also be used for cleaning and wiping all pet areas that veterinary hospitals, zoo's, and general areas, where sanitization is required. It is the primary objective of the present invention to overcome two problems. One, to serve as a device for wiping, cleaning, sanitizing of animal and for collecting and securing fecal matter (animal waste), and two, to aid in the prevention of Zoonotic disease to animal's caused by insect bites, and to have a clean environment free from bacteria. Due to the unique construction of material, anti-bacteria solution, and odor eliminators, with the addition of the strong adhesive tape/strip that secures fecal matter tightly, it prevents the spread of odor and bacteria in the environment. Furthermore by wiping the animal, the present invention contains natural and medicated substances that kill bacteria and eliminate odor from pet, keeping pet clean and sanitized.

### BACKGROUND OF THE INVENTION

1. Field of the Invention

This present invention relates to environmental health and the prevention of Zoonotic disease, more particularly it relates to a animal waste collection and cleaning device that substantially improves the prevention of animal disease and the environment from bacteria. The present invention is directed to the cleaning, sanitization, and collection as it relates to animal waste vis a vis an anti-bacterial wiping and cleaning hand-inserted mitt/pouch, that after wiping, reverses to a poop bag and secures tightly with adhesive tape.

2. Description of the Related Art

Any discussion of the prior art throughout the specification should in no way be considered as an admission that such prior art is widely known or forms part of the common general knowledge in the field.

As illustrated in U.S. Pat. No. 7,192,190 Jung, the use of a plastic bag for the purpose of picking up and collecting animal waste (animal fecal matter)is a device that serves only a single service and its method is likewise limited in scope and functionality as its only providing a single purpose. The prior art's method serves its purpose most effectively, but it goes on to ignore many basic fundamentals in this particular matter, thus being limited in breadth and scope.

### BRIEF SUMMARY OF THE INVENTION

The anti-bacterial wet wipe, reversible to scented plastic poop bag of the present invention not only overcomes the problems associated with the prior art but enhances the collection of animal waste by its functions. Where the prior art failed in its limited scope, this present invention completes the cycle by its all encompassing functions. In every single situation where an owner has to pick up their animal's waste, they are constantly and consistently presented by a number of issues. In general, dog owners are presented by the simple fact that they need to pick up their pet's fecal matter, so that it is not left in public or inappropriate places. In nearly all areas, but very specifically urban one's, pet owners are required by law, such as in New York State, where it is mandated by the Canine Waste Law (Section 1310 of the New York State Public Health Code) and governed by the New York City Department of Health (including Animal Care & Control), of Sanitation, and Parks and Recreation. Any pet owner's failing to pick up their pet's waste and who is found violating them can lead to fines of $2,000. Given that, many dog owner's typically use grocery produce plastic bags to transport the feces of their dog so that it can be disposed properly. On a very fundamental level, the plastic grocery bag often used is turned inside out as the poop is scooped, then disposed of in a trash can. The second issue that we have to contend with is the fecal matter itself and how it impacts the environment. Canine fecal matter are one of the leading sources of E. Coli (fecal coliforms) bacteria pollution: Each gram of dog feces contains over 20,000,000 E. Coli colonies which can measurably affect the environment, the compounded effect of thousands of dogs and cats in a metropolitan area would create problems due to microbe contamination of soil and water supplies. The runoff from neglected pet waste contaminates water, creating a public health hazard for residents, and stream inhabitants like fish. Along with abruptly high volume during storm runoff and resulting turbidity, water quality is ultimately impacted and highly affected. To a further degree, Zoonotic diseases (infectious disease that is able to be transmitted from other animals, both wild and domestic, to humans or from humans to animals) are also of major concern given these bacteria that can be transmitted.

The present invention serves to combat these major issues of animal cleaning, sanitization, and collection and does so very well by its unique elements and construction, and by its innovative design and materials. The present invention speaks to the bacteria issue from the onset. This is achieved by the cleaning solution containing natural or medicated substances that kill bacteria and eliminate odor. With this cleaning solution, wiping an animal's buttocks (and its fur in the surrounding area), and where needed, after it defecates, sanitizes and eliminates bacteria that can attract insects that bite the animal and the same fecal coliforms that have a grave and negative impact on the environment. The wipe mitt/pouch reverses into a poop bag having a two in one function. Therefore after wiping animal, picking up fecal matter is made easy. By reversing the mitt/pouch, it becomes a poop bag to where it rolls and secures fecal matter (animal waste), with its uniquely designed adhesive tape. The invention, containing anti-bacterial solution, reverses afterwards (turns inside out) so that it secures the fecal matter in order to keep environment clean from bacteria and odor. Once it is reversed, the outside layer of poop bag, made of plastic, also contains odor and bacteria eliminators, in order to keep bugs away from any general area when disposed of, adds to keeping a healthy environment. The prior art animal waste bag, did not provide wipe cleaning, anti-bacterial solution, the scented odor-eliminating element, or the degree of security of substance/fecal matter as the present invention does. The prior art therefore only served a single purpose, and that was simply for the collection of animal waste. This present invention goes beyond the collection of animal waste by eliminating odor and bacteria from the environment, and by it serving the purpose of a wipe, inherent by its design.

With this present invention, wiping and cleaning an animal is made easy; hands are not in contact with fecal matter or other animal waste. When reversing into plastic poop bag, hand does not come into contact with fecal matter. You roll up and secure without the hand coming into contact with any fecal matter or other substance during the entire process. Device fits hand like a mitt or a pouch with a thumb insertion, adding to the use and ease of securing the fecal matter or any other animal waste product. This adds to the psychology of people as they will not hesitate to clean animal or pick up fecal matter anymore, benefitting the animal first and foremost and the environment and everything else related to the matter as well. It is another objective with this present invention to be used for cleaning all pet area's in veterinary hospitals and at zoo's for all uses where sanitization is required.

### BRIEF DESCRIPTION OF THE DRAWINGS

FIG. 1 is a plan view of the present invention illustrating the components that make up the preferred embodiments.

FIG. 2 is a side perspective side view of the present invention showing the internal components and how the present inventions functions.

FIG. 3 is a perspective front side view of the present invention illustrating the unique layers and material components.

FIG. 4 is a plan view of the present invention illustrating in particular the thumb insertion and its ability to fold.

FIG. 5 is a plan view of the present invention depicting the mitt/pouches ability to fold easily once fecal matter is collected.

FIG. 6 is a plan view of the present invention depicting how it collects and secures animal waste once it is reversed and adhesive strip is in place.

FIG. 7 is a perspective view of the present invention depicting the different components to the invention once it is reversed and folded and secured by adhesive strip.

### DESCRIPTION OF THE SPECIFIC EMBODIMENTS

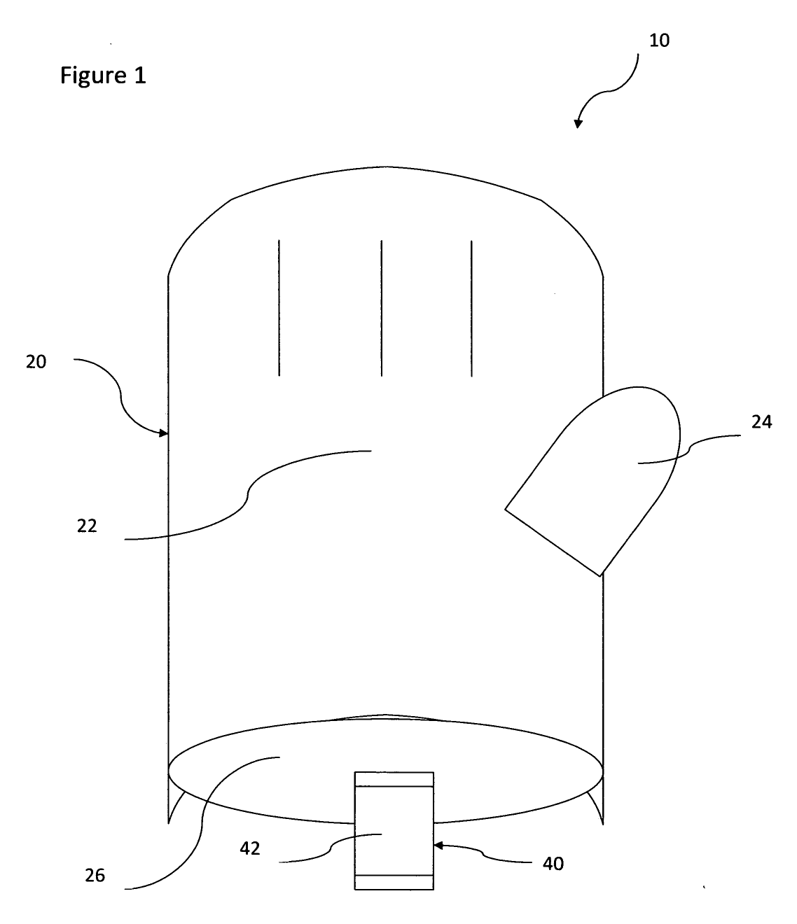

In FIG. 1, anti-bacterial wet wipe, reversible to plastic poop bag 10 has the design of a mitten/pouch 20 with a thumb insertion 24. The outside layer of the mitten/pouch 22, contains the anti-bacterial/sanitizing solution. The inner scented plastic layer 26 once reversed inside out will aid in eliminating odors of the animal waste (fecal matter, etc.). The adhesive tape/strip component 40, will contain a strong adhesive compound to ensure that once the poop bag is turned inside out, that the animal waste collected will be adequately secured inside as to avoid any spill or seeping of animal waste collected.

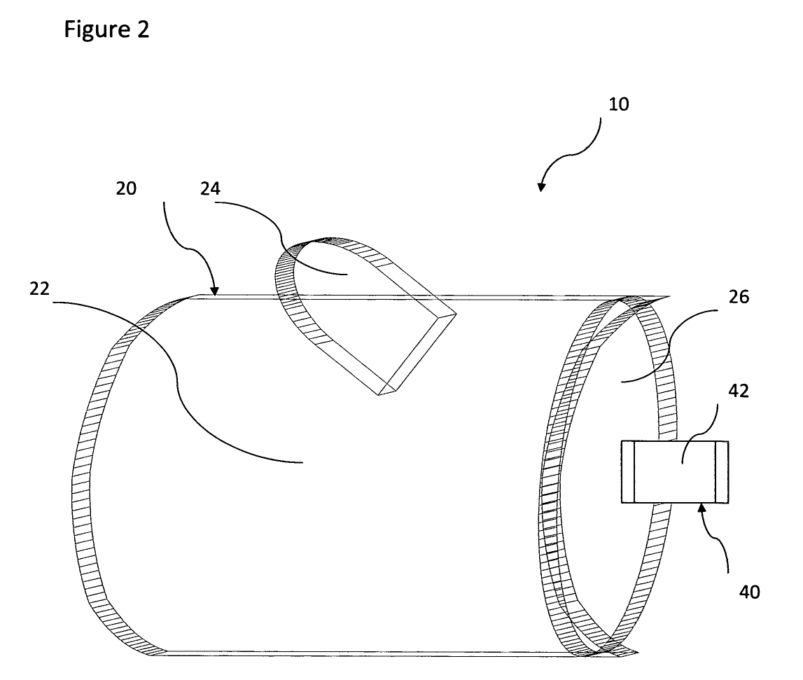

Referring to FIG. 2 we can get a better sense of the present invention 10. Focusing on the outer layer 20, we take a look of a very unique component, the anti-bacterial wet-wipe 22. The wet-wipe will contain a cleaning/sanitizing solution containing natural or medicated substances with the purpose to kill bacteria and eliminate odor. This layer itself will be made out of cotton material, but not limited to. With this cleaning solution, wiping an animal's buttocks (and its fur in the surrounding area), and where needed, after it defecates, cleans and sanitizes the animal and eliminates bacteria that can attract insects that bite the animal and the same fecal coliforms that have a grave and negative impact on the environment. The prior art failed to take into consideration this important element that is so critical in mitigating the impact on the animal and also the benefit that the environment receives as well. Cleaning the animal with a wet-wipe eliminates any mess that is incidental given the nature of the function performed when a animal defecates. This is an enormous enhancement to the prior art and also an attribute that is lacking in the traditional method used of the grocery plastic bag, which obviously does not contain this feature. Without the wet-wipe solution 22, a number of unfortunate circumstances occur: the first is that society and people suffer by introducing the fecal coliforms and their bacteria into the environment; this directly affects the animal and people themselves by placing them in jeopardy of their health, and secondly, the environment is negatively impacted on a grander scale with runoff from neglected pet waste contaminates water, creating a public health hazard for residents, and stream inhabitants like fish. It even goes on to attract insects that are used as carriers of Zoonotic diseases. Another ancillary benefit, especially if the animal suffered from diarrhea, is that an owner does not have to rush home to clean their pet after it defecates, because of this specific component, they are able to clean and sanitize their pet at the time and point that it occurs. This also eliminates the potential threat of risking an insect bite to the animal.

In a very similar spirit, another important component to the is the inner layer 26. The inner layer is scented with odor eliminators. This key component to the mitt/pouch 20 is something that is not present in prior arts. Picture the scenario of an animal owner using the traditional plastic bag; they collect their animal's waste, they wrap it up, then they proceed to the closest trash and throw it out. In this case, apart from the consequence aforementioned in the prior paragraph, there is also the element of odor from the fecal matter and any other animal waste collected, in general. Even at best with the traditional grocery plastic bag being secured as much as possible, the issue of the raw smell and odor that it would emit would still be apparent, and this is more an inevitable circumstance in this case because odors are in the form of a gas, which are difficult to contain. That being said, even the prior art does little to contain this scientific fact. This is where the inner layer 26 comes into pleasant and much demanded introduction. With a scented, odor eliminating layer 26, once the pet is cleaned, sanitized, 22 and then its fecal matter collected 20 and secured 40, the mitt 20 is then turned inside out to utilize its dual function as a poop bag 10. The benefit of having a scented, odor eliminating layer 26, once the bag is turned inside out, the owner can guiltlessly and shamelessly and without disgust, dispose of it to the nearest trash can/receptacle with the notion that even at worst, if awful odor gases do try to escape and have even the slightest success, that the scented, odor eliminating layer will negate this effect, thus keeping the environment and the people included, free from being subjected to any unpleasant, extremely bad smell. For instance, this layer, in one form, but not limited to, can come scented in eucalyptus and lemon which is widely known to be a bug repellent.

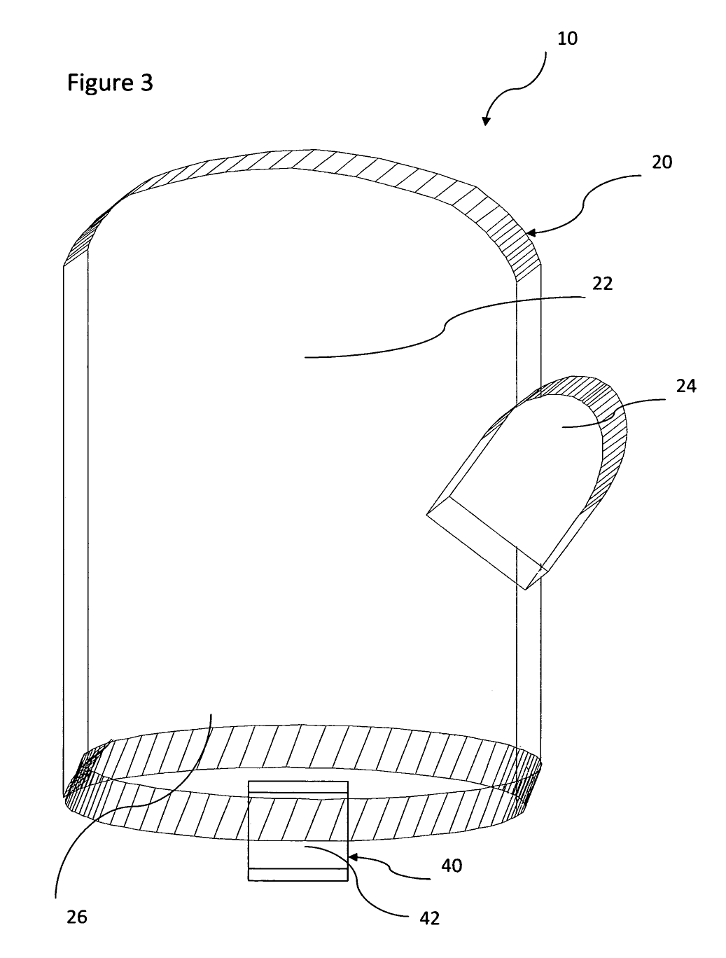

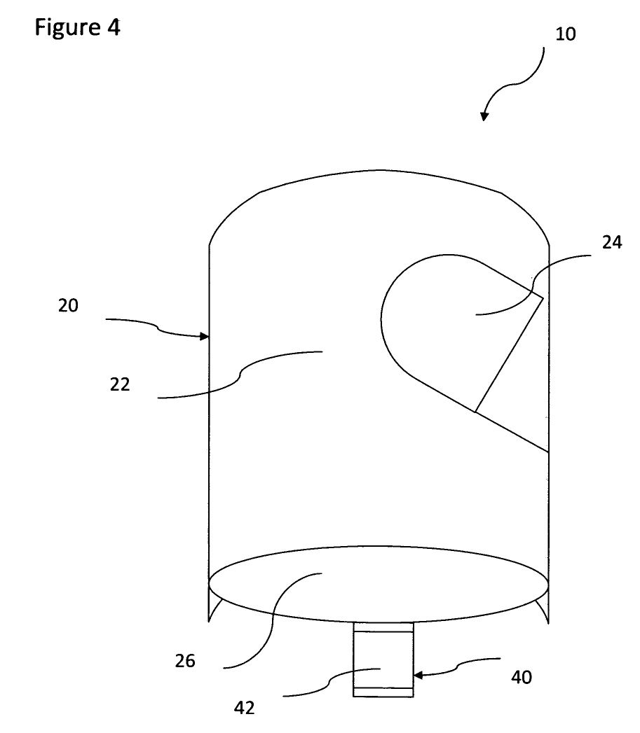

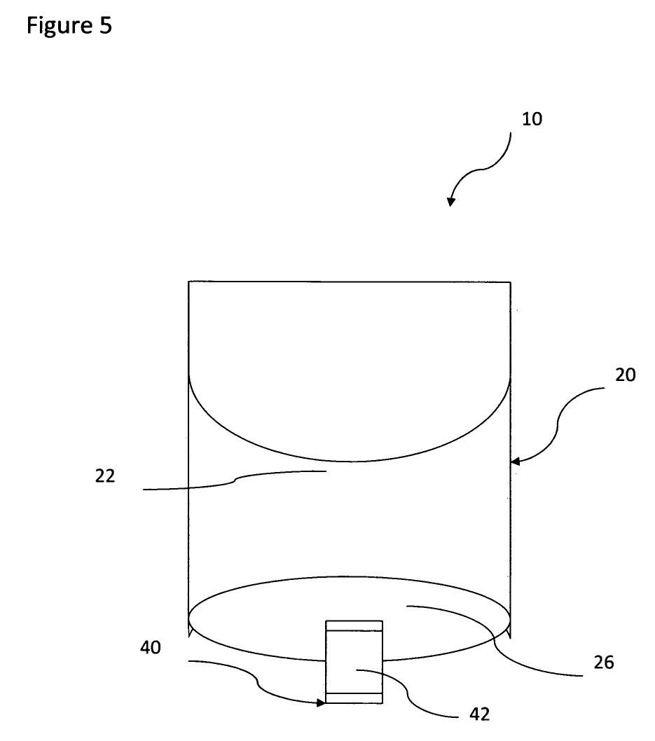

In FIG. 3, we have a perspective front side view that we want to utilize to focus on the present invention 10 and its components that make the handling and collecting of animal waste easier. One of the key components to the mitt/pouch 10, is the design 20 to easily accommodate a hand and the counters of it, with the added thumb insertion 24. By having this very intuitive and unique design, the user (pet owner), has the ability to simply slide their hand into the device 10 and position their thumb into the thumb insertion component 24 safe and securely. The design 20 is intentionally fashioned so that it accepts a human hand with added benefit of the thumb insertion 24 in order to enhance the function of wiping, cleaning, sanitizing, and the collecting and securing of animal waste. By having better positioning, this decreases or totally eliminates any fumbling of the animal waste and safeguards against the chance that once the animal waste is collected, that it accidentally drops or falls out and thus causing an unfortunate scenario, such as the fecal matter falling onto something someone wants to avoid, for example and arguments sake, let's say the pet owner's own shoe. FIG. 4 simply goes on to illustrate that the thumb insertion 24 component will have attribute of flexibility and limberness to make the collection of the animal's waste more manageable. FIG. 5 likewise goes on to further illustrate how the entire unit 10 will have the suppleness of a soft mitt/pouch, and remain true to form in that manner in order to sustain its suppleness to make the entire process of functions more manageable and easy.

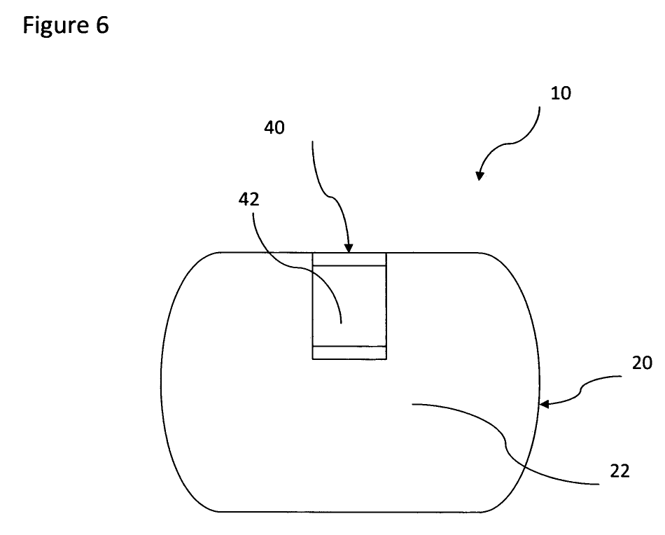

FIG. 6 focuses on the adhesive component 40 of the present invention. By using a strong adhesive compound 42, we take all the necessary and appropriate steps in order to ensure that the function of securing the animal waste is taken into perspective. Where the use of the traditional plastic grocery bag fails to address the need to secure an animal's waste properly, this present invention excels in the matter. The adhesive component 40 will be sufficient in size in order to guarantee its efficacy, by ensuring that it fully encompasses the animal waste that needs to be secured and that there is no opening for the animal waste to escape from the material. This in turn will aid in the prevention of animal waste and the inherent bacteria source of fecal coliforms taken their impact on the environment as previously explained.

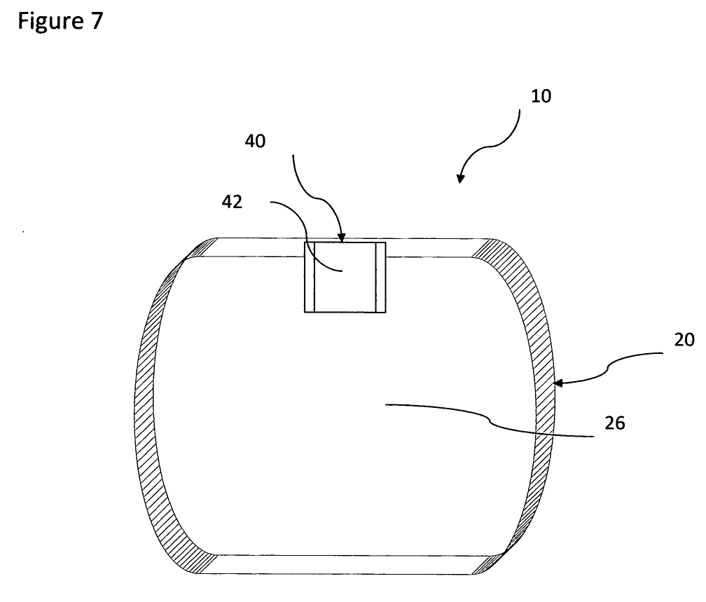

Referring to FIG. 7, we have a perspective view of what the present invention 10 will look like when it has been utilized through its functions and it is ready to be disposed of. The mitt/pouch 20 design, after the waste is collected and turned inside out and folded, will have the appearance of an ordinary bag. Once turned inside out, the once inner scented, odor-eliminating layer 26, will now become the outside layer as it is “reversed”. This layer will now play an integral role in keeping the environment free of any animal waste odor. The adhesive tape/strip component 40, will also play a vital role in the securing of the animal waste so that none escapes and comes into with the environment. In all, its compact design 20 will allow for easy disposal, and give it an inconspicuous look, as needed, for things of this nature don't need attention drawn to them specifically.

1. Anti-bacterial wet or dry wipe made out of cotton material, but not limited to, with a natural or medicated solution, including baking soda, but not limited to, to clean, sanitize, and collect animal waste, reversible to plastic scented (scents such as eucalyptus and lemon, but no limited to), odor-eliminating poop bag, with the unit shaped in the fashion of a mitt/pouch, but not limited to, with thumb insertion, and adhesive tape/strip component to secure animal waste, and compact design for easy disposal.
